(19) United States
(12) Patent Application Publication
(10) Pub. No.: US 2012/0313550 A1
(43) Pub. Date: Dec. 13, 2012

(54) APPARATUS AND METHOD FOR DRIVING COLD CATHODE FLUORESCENT LAMP BY DETECTING DRIVING CHARACTERISTIC OF COLD CATHODE FLUORESCENT LAMP

(76) Inventor: Yu-En Lee, New Taipei City (TW)

(21) Appl. No.: 13/442,822

(22) Filed: Apr. 9, 2012

(30) Foreign Application Priority Data
Jun. 10, 2011 (TW) 100120391

(51) Int. Cl. H05B 41/36

(52) U.S. Cl. 315/307

(57) ABSTRACT

A driving apparatus for a cold cathode fluorescent lamp (CCFL), including a driving circuit, a detecting element and a control circuit. The driving circuit is for driving the CCFL. The detecting element is for detecting a driving characteristic of the CCFL as a detection output. The control circuit is coupled to the detecting circuit and the driving, and used for controlling the driving circuit according to the detection output.

### BACKGROUND OF THE INVENTION

1. Field of the Invention

The present invention relates to a driving apparatus and a corresponding method of a cold cathode fluorescent lamp (CCFL), and more particularly, to a driving apparatus and a corresponding method of adjusting driving current of the CCFL according to a detection result of the CCFL.

2. Description of the Prior Art

The cold cathode fluorescent lamp (CCFL) is a kind of fluorescent lamp. The CCFL typically has a layer of fluorescence coated on the inner wall of the lamp, and has few inactive gas and a small amount of mercury enclosed therein. When energized by an applied voltage, the electrons of mercury would collide with the atoms of the inactive gas to generate the ultraviolet ray, and the ultraviolet ray is then converted into visible light through the fluorescence coated on the inner wall of the lamp. Due to CCFL's inherent characteristics including long life, small volume, low power consumption, high brightness, high lumen, high performance, etc., the CCFL is often used in daily lighting application.

However, a typical CCFL is significantly influenced by temperature. In the condition of a low temperature, the brightness of the lamp obviously decreases, and the voltage required to turn on the lamp increases, and the self heating of the lamp significantly affects the brightness after the lamp is turned on. For example, because the CCFL heats slowly, the heating time needs to be extended to make the CCFL achieve the desired brightness successfully.

### SUMMARY OF THE INVENTION

The present invention therefore provides a driving apparatus and a corresponding driving method of a CCFL to solve the problems mentioned above.

An embodiment of the present invention discloses a driving apparatus applied to a CCFL. The driving apparatus includes a driving circuit, a detection element and a control circuit. The driving circuit is arranged to drive the CCFL. The detection element is arranged to detect a driving characteristic of the CCFL as a detection output. The control circuit is coupled to the detection element and the driving circuit, arranged to control the driving circuit according to the detection output.

Another embodiment of the present invention discloses a driving method applied to a CCFL. The driving method includes: detecting a driving characteristic as a detection output; and control the CCFL according to the detection output.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a driving apparatus arranged to drive a CCFL according to an embodiment of the present invention.

FIG. 2 illustrates a control circuit according to an embodiment of the present invention.

FIG. 3 illustrates the architecture of a driving apparatus arranged to drive a CCFL according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

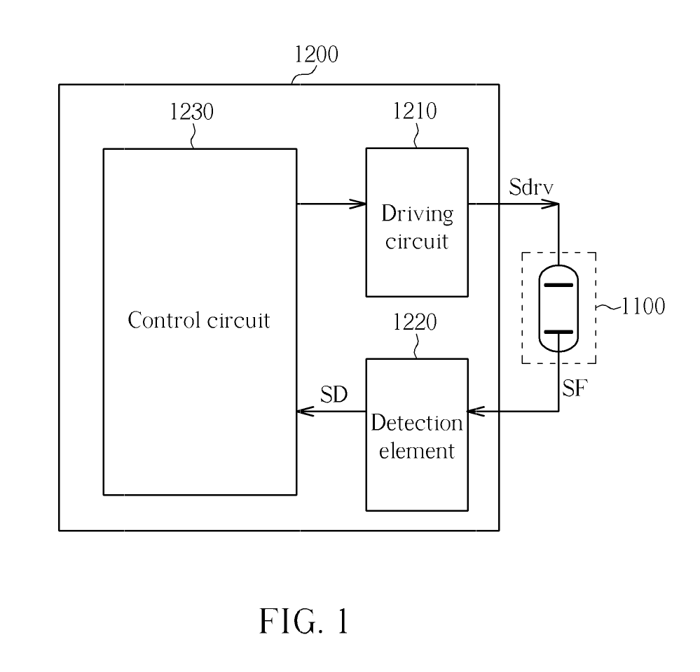

Please refer to FIG. 1, which is a diagram illustrating a driving apparatus 1200 arranged to drive a CCFL 1100 according to an embodiment of the present invention. The driving apparatus 1200 includes a driving circuit 1210, a detection element 1220 and a control circuit 1230. The driving circuit 1210 is arranged to drive the CCFL 1100. The detection element 1220 is arranged to detect a driving characteristic SF of the CCFL 1100 as a detection output SD. In this example, the driving characteristic SF is taken as a current of the CCFL 1100, which means that the detection element 1220 may detect a driving current of the CCFL 1100 to generate the detection output SD. The control circuit 1230 controls the driving circuit 1210 according to the detection output SD, in order to adjust the driving current of the CCFL 1100. When the detection output SD presents a first value, the control circuit 1230 controls the driving circuit 1210 to set the CCFL 1100 to have a first driving current; and when the detection output SD presents a second value different from the first value, the control circuit 1230 controls the driving circuit 1210 to set the CCFL 1100 to have a second driving current different from the first driving current. However, the example mentioned above is only a better embodiment of the present invention, and is not meant to be a limitation of the present invention. For example, the detection element 1220 can also detect a temperature of the CCFL 1100 as the detection output SD. When the temperature is too low, the control circuit will control the driving circuit 1210 to adjust the CCFL 1100 such that the driving current is boosted to increase the start-up speed and brightness of the CCFL 1100.

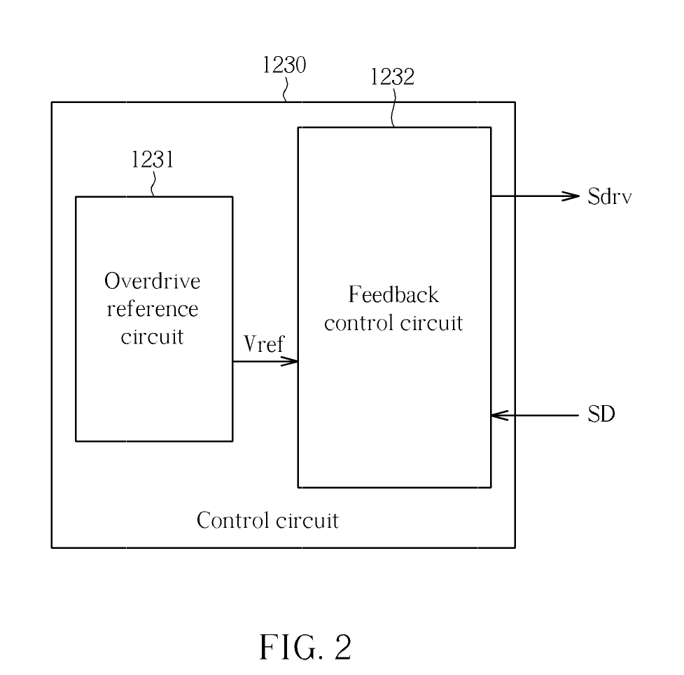

Please refer FIG. 2 to further understand the operation of the control circuit 1230. FIG. 2 illustrates the architecture of the control circuit 1230 according to an embodiment of the present invention. The control circuit 1230 includes an overdrive reference circuit 1231 and a feedback circuit 1232. Herein, the overdrive reference circuit 1231 is arranged to generate a reference voltage Vref to the feedback control circuit 1232, and the feedback control circuit 1232 is arranged to generate a driving signal Sdrv according to the detection output SD and the reference voltage Vref, in order to control the driving circuit 1210 to adjust the driving current of the CCFL 1100, wherein the overdrive reference circuit 1231 generates a first reference voltage at a first time point, and generates a second reference voltage different from the first reference voltage at a second time point different from the first time point.

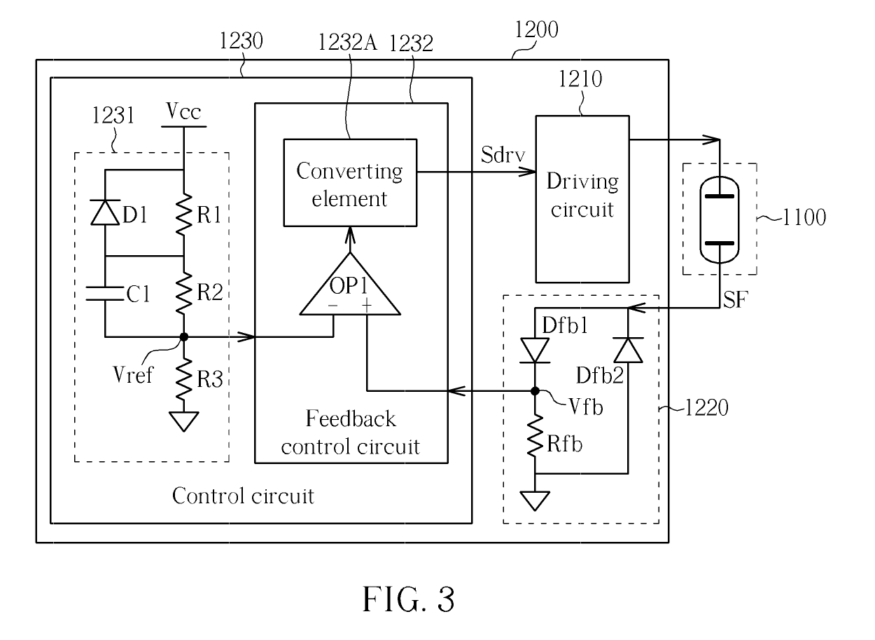

Please refer to FIG. 3 to understand the detailed operation of the driving apparatus 1200. FIG. 3 illustrates the architecture of the driving apparatus 1200 of the CCFL 1100 according to an embodiment of the present invention. In the example shown in FIG. 3, the overdrive reference circuit 1231 has a diode D1, a capacitor C1 and resistors R1, R2, and R3, and receives a supply voltage Vcc. The detection circuit 1220 has a resistor Rfb and diodes Dfb1 , Dfb2. And the feedback control 1232 has an OP amplifier OP1 and a converting element 1232A. The OP amplifier OP1 may compare two voltages (i.e., Vref and Vfb) at its inputs, and then transfer the comparison result to the driving circuit 1232A. The converting element 1232A may convert the received comparison result into the control signal generated to the driving circuit 1210. The detection circuit 1220 may convert the driving current of the CCFL 1100 into a voltage signal, therefore it is obtained:

I=Vfb/Rfb (1)

wherein I is the driving current.

Please note, due to the circuitry mechanism of the OP amplifier OP1, the voltage Vfb may be adjusted to equal the voltage Vref. Because of the intrinsic circuitry characteristic of the overdrive reference circuit 1231, the following equation can be obtained once the overdrive reference circuit 1231 is turned on.

Vref=(Vcc×R3)/(R1+R3) (2)

Therefore, when the CCFL 1100 is just turned on, the driving current of the CCFL 1100 can be expressed as follows.

I=[(Vcc×R3)/(R1+R3)]/Rfb (3)

After a period of time T since start-up of the CCFL 1100, because of the intrinsic circuitry characteristic of the overdrive reference circuit 1231, the following equations can be obtained.

Vref=(Vcc×R3)/(R1+R2+R3) (4)

T=5[(R1+R3)//R2]×C1 (5)

Thus, after the period of time T (i.e., the required start-up time) since start-up of the CCFL 1100, the driving current of the CCFL 1100 can be expressed as follows.

I=[(Vcc×R3)/(R1+R3+R3)]/Rfb (6)

As can be known from the equations above, the driving current of the CCFL 1100 is higher as the CCFL 1100 is just turned on, thereby accelerating the start-up of the CCFL 1100. After a period of time since start-up of the CCFL 1100, the driving current of the CCFL 1100 may decrease and keep steady, to prevent the CCFL 1100 from having shorter life or being broken. Please note, the present invention further provides a mechanism to prevent the driving signal Sdrv from increasing the driving current of the CCFL 1100 too high, in order to stop the comparatively large driving current from passing through the CCFL 1100 and resulting in damage to the CCFL. When the driving characteristic SD detected by the detection element 1220 is higher than a threshold value, the feedback control circuit 1232 may limit the driving signal SD within a predetermined range to thereby prevent the driving current from surpassing a threshold current value and thus damaging the CCFL 1100.

To sum up, the present invention provides a driving apparatus for a CCFL and the associated driving method. The driving apparatus of the present invention can adjust a driving current of the CCFL to increase the start-up speed or brightness, by detecting the driving characteristic of the CCFL. Additionally, the present invention further provides a protection mechanism to prevent the driving current from being too high and thus damaging the CCFL.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving apparatus arranged for a cold cathode fluorescent lamp(CCFL), comprising:
a driving circuit, arranged for driving the CCFL;
a detecting element, arranged for detecting a driving characteristic of the CCLF as a detection output; and
a control circuit, coupled to the detecting element and the driving circuit, the control circuit arranged to control the driving circuit according the detection output.

2. The driving apparatus of claim 1, wherein when the detection output presents a first value, the control circuit controlling the driving circuit to set the CCFL with a first driving current; and when the detection output presents a second value different from the first value, the circuit controlling the driving circuit to set the CCFL with a second driving current different from the first driving current.

3. The driving apparatus of claim 1, wherein the detecting element detects a driving current of the CCFL to generate the detection output.

4. The driving apparatus of claim 3, wherein the control circuit comprising:
an overdrive reference circuit, arranged for generating a reference voltage; and
a feedback control circuit, coupled to the overdrive reference circuit, the feedback control circuit arranged to generate a driving signal according to the detection output and the reference voltage, wherein the driving signal controls the driving circuit to adjust the driving current of the CCFL.

5. The driving apparatus of claim 4, wherein the overdrive reference circuit generates a first reference voltage at a first time point, and generates a second reference voltage different from the first reference voltage at a second time point different from the first time point.

6. The driving apparatus of claim 4, wherein when the driving characteristic detected by the detection element is higher then a threshold value, the feedback control circuit limits the driving signal within a predetermined range to prevent the driving current from surpassing a threshold current value.

7. A driving method for a cold cathode fluorescent lamp(CCFL) comprising:
detecting a characteristic of the CCFL as a detection output; and
controlling the CCFL according to the detection output.

8. The driving method of claim 7, wherein when the detection output presents a first value, the CCFL is set to have a first driving current; and when the detection output presents a second value different from the first value, the CCFL is set to have a second driving current different from the first driving current.

9. The driving method of claim 7, wherein the detection output is generated according to a driving current of the CCFL.

10. The driving method of claim 9, wherein the steps of controlling the CCFL according to the detection output comprising:
generating a reference voltage; and
generating a driving signal to adjust the driving current of the CCFL according to the detection output and the reference voltage.

11. The driving method of claim 10, wherein the step of generating the reference voltage comprising:
at a first time point, generating a first reference voltage; and
at a second time point different from the first time point, generating a second reference voltage different from the first reference voltage.

12. The driving method of claim 10, wherein when the driving characteristic surpasses a threshold value, the driving signal is limited within a predetermined range to prevent the driving current from surpassing a threshold current value.
